(19) United States
(12) Patent Application Publication
(10) Pub. No.: US 2026/0189681 A1
(43) Pub. Date: Jul. 2, 2026

(54) PROJECTION BLENDING AND CALIBRATION METHOD, CONTROL DEVICE AND PROJECTION SYSTEM

(71) Applicant: Coretronic Corporation, Hsin-Chu (TW)

(72) Inventors: Chien-Chun Peng, Hsin-Chu (TW); Yen-Hua Chen, Hsin-Chu (TW); Chen-Ming Li, Hsin-Chu (TW); Chia-Yen Ou, Hsin-Chu (TW)

(73) Assignee: Coretronic Corporation, Hsin-Chu (TW)

(21) Appl. No.: 19/408,231

(22) Filed: Dec. 3, 2025

(30) Foreign Application Priority Data
Dec. 30, 2024 (CN) 202411959160.9

(51) Int. Cl. H04N 9/31; G09G 3/00; G09G 3/20

(52) U.S. Cl. CPC H04N 9/3147; G09G 3/002; G09G 3/2096; H04N 9/3179; H04N 9/3194; G09G 2340/12; G09G 2360/04

(57) ABSTRACT

Provided are a projection blending and calibration method, a control device, and a projection system. The method includes: multiple conversion matrices respectively corresponding to multiple projection devices are obtained; sub-projection images projected by the projection devices are to be blended into a projection image; the projection devices respectively correspond to multiple imaging devices; each of the projection devices is controlled to project a first test pattern; each of the imaging devices is controlled to individually capture the first test pattern projected by each of the corresponding projection devices to obtain multiple first image frames having the first test pattern; multiple first homography matrices are obtained based on the first image frames; the first homography matrices respectively correspond to the conversion matrices; and each of the first homography matrices is respectively converted based on a corresponding conversion matrix of the conversion matrices to obtain multiple second homography matrices.

### CROSS-REFERENCE TO RELATED APPLICATION

This application claims the priority benefit of China application serial no. 202411959160.9, filed on Dec. 30, 2024. The entirety of the above-mentioned patent application is hereby incorporated by reference herein and made a part of this specification.

### BACKGROUND

### Technical Field

The disclosure relates to a projection technology, and particularly relates to a projection blending and calibration method, a control device, and a projection system.

### Related Art

In an application scenario where multiple projection devices perform blending, the blending effect may be implemented by multiple projection devices projecting images, thereby enhancing the overall display resolution. This technology may be applied to various projection surfaces, including planar, curved, cylindrical, spherical, or other irregular shapes. However, due to different curvature characteristics of different projection surfaces, the multiple projection devices need to adjust the projection images according to the installation conditions during blending to ensure that the blended image meets the viewing needs of the user.

Traditionally, manual adjustment of projection images is feasible, but the process is time-consuming and complicated. In some application scenarios that have a higher demand for accuracy, such as planetariums or military simulators, maintenance needs to be regularly performed to ensure the quality stability of blending and fusion for multiple projection devices.

Please refer to FIG. 1, which is a schematic diagram of installing multiple projection devices in the prior art. In the architecture of multiple projection devices shown in FIG. 1, the related operation process is usually that projection devices 101 to 105 are controlled by a control device 120 to project a test image, and then a main imaging device 110 (such as a camera) is instructed to capture to obtain an image that captures the test image projected by each projection device to perform calibration.

However, the foregoing approach currently has some issues. For example, when the imaging device 110 does not have a fixed location, manual on-site adjustment is needed, increasing operation complexity and time cost. If the installation location of the imaging device 110 overlaps with the viewer's viewing angle, maintenance and viewing experience might be affected. Moreover, the installation location of the imaging device 110 might be changed during maintenance, leading to deviations in image uniformity or location precision. If an external factor leads to a projection image shift during the display process, the prior art may find it difficult to immediately restore, which might affect the display quality.

The foregoing issues need to be improved to enhance the operation efficiency, maintenance convenience, and daily operation stability of the blending technology of the multiple projection devices.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

Other objectives and advantages of the disclosure may be further understood from the technological features disclosed herein. At least one of the technical problems to be solved by the disclosure is how to design a technological feature that can enhance the operation efficiency, maintenance convenience, and daily operation stability of the blending technology of multiple projection devices.

To achieve one or part or all of the foregoing objectives or other objectives, an embodiment of the disclosure provides a projection blending and calibration method, which includes the following steps: multiple conversion matrices respectively corresponding to multiple projection devices are obtained by a control device; sub-projection images projected by the multiple projection devices are to be blended into a projection image; the multiple projection devices respectively correspond to multiple imaging devices; each of the multiple projection devices is controlled by the control device to project a first test pattern; each of the multiple imaging devices is controlled by the control device to individually capture the first test pattern projected by each of the corresponding projection devices to obtain multiple first image frames that have the first test pattern; multiple first homography matrices are obtained based on the multiple first image frames by the control device; the multiple first homography matrices respectively correspond to the multiple conversion matrices; each of the first homography matrices is respectively converted based on a corresponding conversion matrix of the multiple conversion matrices to obtain multiple second homography matrices; and the multiple second homography matrices are combined by the control device to obtain a compensation coefficient coordinate matrix corresponding to the multiple projection devices.

To achieve one or part or all of the foregoing objectives or other objectives, an embodiment of the disclosure provides a control device, which is coupled to multiple projection devices, and configured to control the multiple projection devices. The control device includes a storage circuit and a processor. The storage circuit is configured to store a program code. The processor is coupled to the storage circuit and accesses the program code to: obtain multiple conversion matrices respectively corresponding to the multiple projection devices by the control device; sub-projection images projected by the multiple projection devices are to be blended into a projection image; the multiple projection devices respectively correspond to multiple imaging devices; control each of the multiple projection devices by the control device to project a first test pattern; control each of the multiple imaging devices by the control device to individually capture the first test pattern projected by each of the corresponding projection devices to obtain multiple first image frames that have the first test pattern; obtain multiple first homography matrices based on the multiple first image frames by the control device, the multiple first homography matrices respectively correspond to the multiple conversion matrices; convert each of the first homography matrices respectively based on a corresponding conversion matrix of the multiple conversion matrices to obtain multiple second homography matrices by the control device; and combine the multiple second homography matrices by the control device to obtain a compensation coefficient coordinate matrix corresponding to the multiple projection devices.

To achieve one or part or all of the foregoing objectives or other objectives, an embodiment of the disclosure provides a projection system, which includes multiple projection devices, multiple imaging devices and a control device. The multiple projection devices are respectively configured to project sub-projection images. The individual sub-projection images of the multiple projection devices are configured to be blended into a projection image. The control device is coupled to the multiple projection devices and the multiple imaging devices. The control device is configured to: obtain multiple conversion matrices respectively corresponding to the multiple projection devices; the sub-projection images projected by the multiple projection devices are to be blended into the projection image; the multiple projection devices respectively correspond to the multiple imaging devices; control each of the multiple projection devices to project a first test pattern; control each of the multiple imaging devices to individually capture the first test pattern projected by each of the corresponding projection devices to obtain multiple first image frames that have the first test pattern; obtain multiple first homography matrices based on the multiple first image frames; the multiple first homography matrices respectively correspond to the multiple conversion matrices; convert each of the multiple first homography matrices respectively based on a corresponding conversion matrix of the multiple conversion matrices to obtain multiple second homography matrices; and combine the multiple second homography matrices to obtain a compensation coefficient coordinate matrix corresponding to the multiple projection devices.

In summary, the embodiments of the disclosure may effectively enhance the operation efficiency, maintenance convenience, and daily operation stability of the blending technology of the multiple projection devices.

### BRIEF DESCRIPTION OF THE DRAWINGS

FIG. 1 is a schematic diagram of installing multiple projection devices in the prior art.

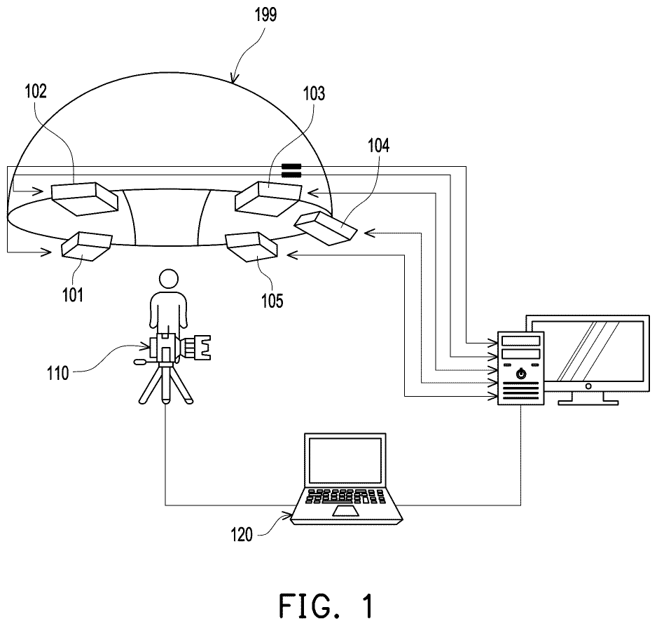

FIG. 2 is a schematic diagram of a projection system according to an embodiment of the disclosure.

FIG. 3 is a flow chart of a projection blending and calibration method according to an embodiment of the disclosure.

FIG. 4 is a schematic diagram of first image frames obtained by each imaging device according to an embodiment of the disclosure.

FIG. 5 is an application scenario diagram according to an embodiment of the disclosure.

FIG. 6 is a flow chart of determining a conversion matrix according to an embodiment of the disclosure.

FIG. 7 is another schematic diagram of the projection system according to FIG. 2.

FIG. 8 is a schematic diagram of reference image frames obtained by a main imaging device according to an embodiment of the disclosure.

FIG. 9 is a schematic diagram of second image frames obtained by each imaging device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

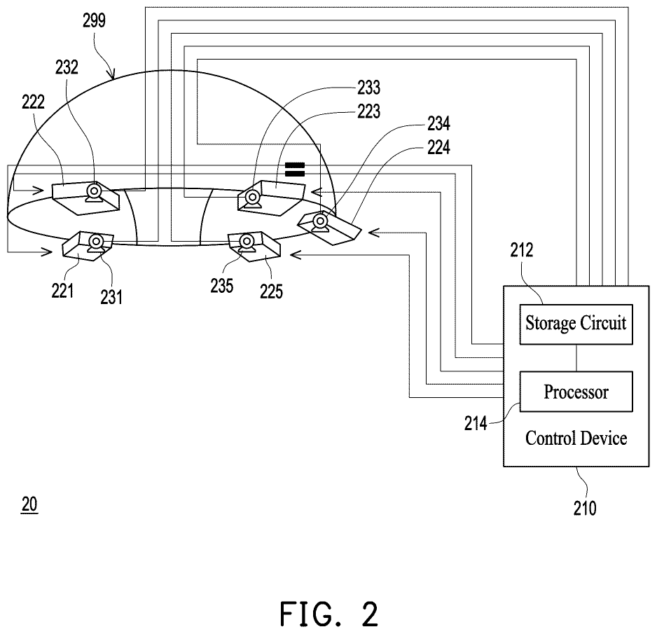

Please refer to FIG. 2, which is a schematic diagram of a projection system according to an embodiment of the disclosure. In FIG. 2, a projection system 20 includes a control device 210, projection devices 221 to 225, and imaging devices 231 to 235.

In different embodiments, the control device 210 may be implemented as various smart devices and/or computer devices, such as personal computers, smartphones, tablet computers, cloud servers or web servers, but the disclosure is not limited thereto.

In FIG. 2, the control device 210 may include a storage circuit 212 and a processor 214. The storage circuit 212 is, for example, any type of a fixed or movable memory, such as a randomaccess memory (RAM), a read-only memory (ROM), a flash memory, a hard disk or other similar devices or a combination of the devices, which may be configured to record multiple program codes, modules or applications.

The processor 214 may include one or more processors. The processor 214 is coupled to the storage circuit 212, and may be a general-purpose processor, a specific-purpose processor, a traditional processor, a digital signal processor, multiple microprocessors, one or more microprocessors combined with a digital signal processor core, a controller, a microcontroller, an application specific integrated circuit (ASIC), a field programmable gate array (FPGA), any other type of integrated circuit, a state machine, a processor based on an Advanced RISC machine (ARM) architecture, or the like.

In FIG. 2, the projection devices (projectors) 221 to 225 may be individually configured to project corresponding sub-projection images on a projection surface 299. The individual sub-projection images of the projection devices 221 to 225 may be configured to be blended into a projection image. The projection surface 299 is, for example, a planar surface, a curved surface, a dome projection surface, or a surface with curvature characteristics.

The sub-projection images individually projected by each of the projection devices 221 to 225 are, for example, projected onto a certain region of the projection surface 299. When each of the projection devices 221 to 225 projects the corresponding sub-projection image at the same time, the multiple sub-projection images from the projection devices 221 to 225 may be blended to integrally form a complete projection image.

In the embodiment of the disclosure, the projection devices 221 to 225 may respectively correspond to the imaging devices (cameras) 231 to 235. In an embodiment, each of the imaging devices 231 to 235 may be configured to capture the sub-projection images projected by the corresponding projection devices 221 to 225. That is, an imaging range of each of the imaging devices 231 to 235 may at least cover a projected region of the sub-projection images projected by the corresponding projection devices 221 to 225 on the projection surface 299.

For example, the imaging device 231 may be configured to capture the sub-projection image projected by the corresponding projection device 221. The imaging range of the imaging device 231 may, for example, include the sub-projection image from the projection device 221 and an overlapping region of the sub-projection image with other adjacent sub-projection images. Similar concepts may be applied to the other imaging device 232 to the imaging device 235, and the details of which are not reproduced here.

It should be understood that, although FIG. 2 illustrates the control device 210 as a device located outside the projection devices 221 to 225, the control device 210 may be implemented as a device disposed in one of the projection devices 221 to 225 (such as the projection device 221) in other embodiments. That is, the processor 214 of the control device 210 is, for example, one of multiple processors of the projection device 221. The storage circuit 212 of the control device 210 is, for example, one of multiple storage circuits of the projection device 221. The control device 210 may further include a control interface (such as an on-screen display (OSD) of the projection device 221). The user may send a control signal through the control interface to the projection devices 221 to 225.

In an embodiment, the imaging devices 231 to 235 may, for example, be connected to the projection devices 221 to 225 through a wired/wireless communication connection. Alternatively, the imaging devices 231 to 235 are disposed in the projection devices 221 to 225. The control device 210 may be connected to the projection devices 221 to 225 by various wired/wireless (such as internet of things technology) communication connection, so as to send control signals required by the projection devices 221 to 225 and the imaging devices 231 to 235 and/or perform related data exchange. In another embodiment, the control device 210 may be respectively connected (coupled) to the projection devices 221 to 225 and the imaging devices 231 to 235 by various wired/wireless communication connection in order to send control signals needed to the projection devices 221 to 225 and the imaging devices 231 to 235 and/or perform related data exchange.

In the embodiment of the disclosure, the processor 214 may access a module or a program code recorded in the storage circuit 212 to implement the projection blending and calibration method proposed in the disclosure, and the details of which are described below.

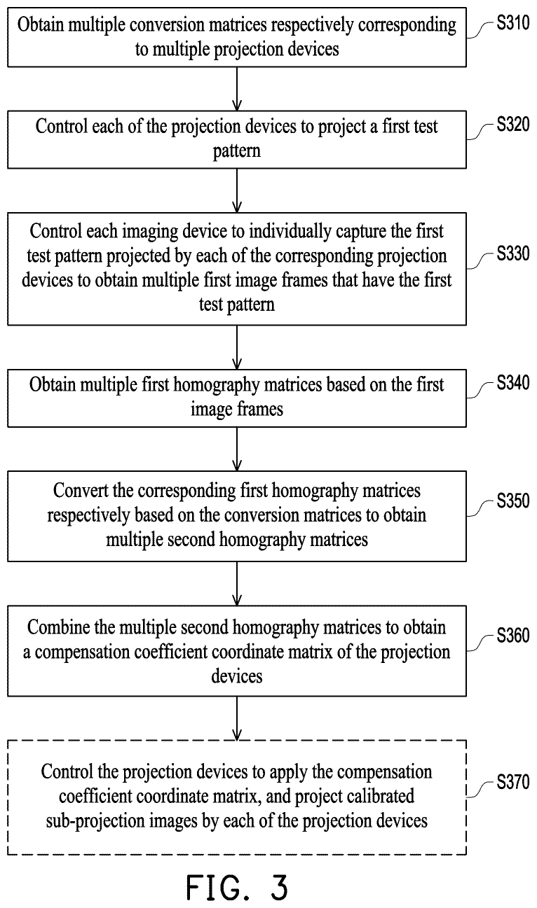

Please refer to FIG. 3, which is a flow chart of a projection blending and calibration method according to an embodiment of the disclosure. The method of the embodiment may be executed by the control device 210 of FIG. 2. The details of each step in FIG. 3 will be illustrated below in conjunction with the elements shown in FIG. 2.

In step S310, the processor 214 obtains multiple conversion matrices respectively corresponding to the projection devices 221 to 225.

In the embodiment of the disclosure, the multiple conversion matrices may, for example, be represented by Md_1 to Md_N. Nis the number of the multiple conversion matrices. Md_i is an i-th conversion matrix among the multiple conversion matrices (i is an index value). The multiple conversion matrices are, for example, stored in the storage circuit 212 of the control device 210.

In the embodiment of the disclosure, N may, for example, be the same as a number of projection devices in the projection system. For example, referring to FIG. 2, the projection system 20 includes 5 projection devices 221 to 225, so N may, for example, have a value of 5, but the disclosure is not limited thereto.

For ease of understanding, 5 is taken as an example of N for illustration below, but this is only for illustrative purposes and is not intended to limit the possible implementations of the disclosure.

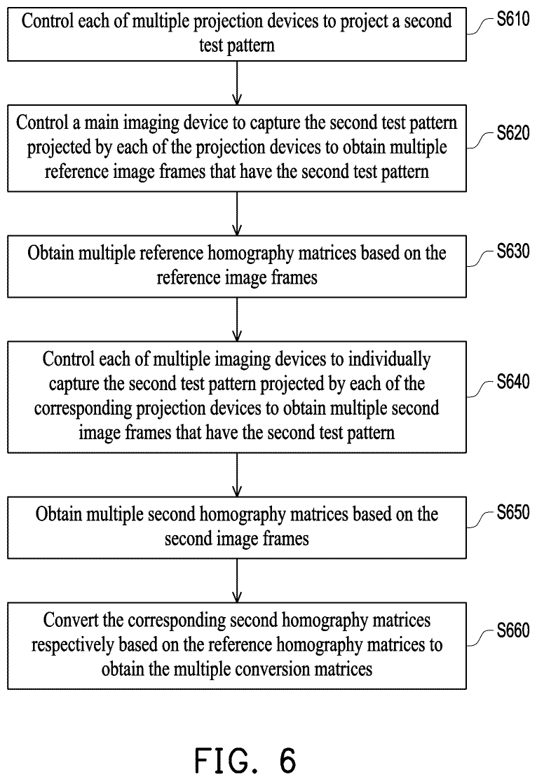

In some embodiments, the conversion matrices Md_1 to Md_5 may, for example, be determined by a specific procedure, and the related details will be illustrated later with reference to the corresponding FIG. 6.

In step S320, the processor 214 controls each of the projection devices 221 to 225 to project a first test pattern. In step S330, the processor 214 controls each of the imaging devices 231 to 235 to individually capture the first test pattern projected by each of the corresponding projection devices 221 to 225 to obtain multiple first image frames that have the first test pattern.

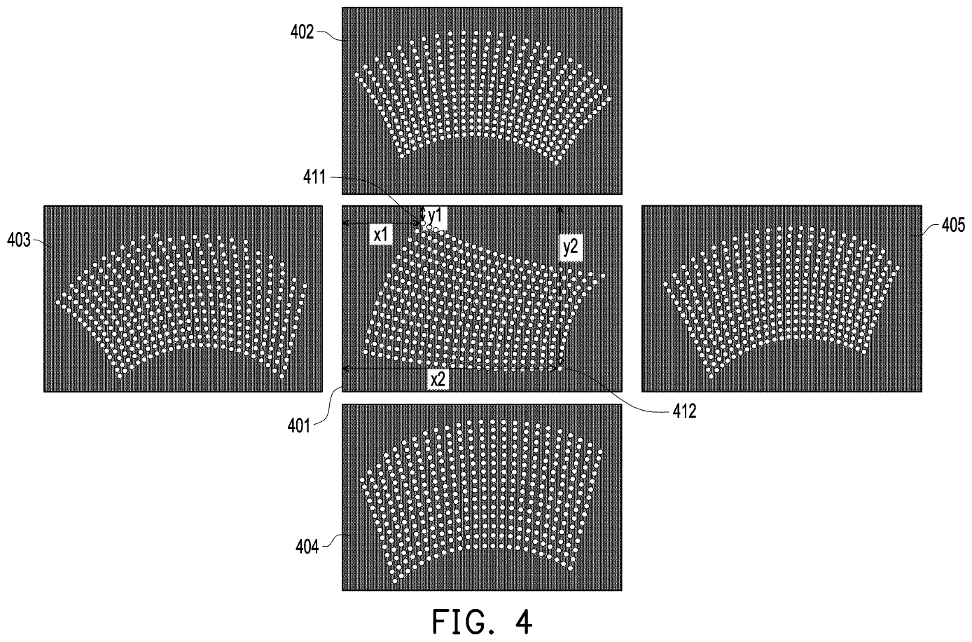

Please refer to FIG. 4, which is a schematic diagram of first image frames obtained by each imaging device according to an embodiment of the disclosure.

In the embodiment, the first test pattern may, for example, include multiple first point positions (such as multiple dots shown in FIG. 4), and the multiple first point positions may, for example, be arranged as an A×B bitmap (dot matrix pattern). In the scenario of FIG. 4, A (number of rows in the matrix) and B (number of columns in the matrix) are respectively, for example, 15 and 24, but the disclosure is not limited thereto.

In an embodiment, the processor 214 may control the projection devices 221 to 225 to independently project the first test pattern in sequence, and control the corresponding imaging devices 231 to 235 to capture when the corresponding projection devices independently project the first test pattern to obtain corresponding first image frames 401 to 405.

For example, the processor 214 may independently control the projection device 221 to project the first test pattern, and control the corresponding imaging device 231 to capture the first test pattern projected by the projection device 221 to obtain the first image frame 401 that has the first test pattern. From the first image frame 401, it can be seen that the first test pattern projected by the projection device 221 appears distorted due to a projected region on the projection surface 299.

In other words, the processor 214 may control only the projection device 221 to project the first test pattern and control the imaging device 231 to capture the first test pattern to obtain the first image frame 401 in a condition where the other projection devices 222 to 225 are controlled not to project.

Similarly, the processor 214 may independently control the projection device 222 to project the first test pattern, and control the corresponding imaging device 232 to capture the first test pattern projected by the projection device 222 to obtain the first image frame 402 that has the first test pattern. In other words, the processor 214 may control only the projection device 222 to project the first test pattern and control the imaging device 232 to capture the first test pattern to obtain the first image frame 402 in a condition where the other projection devices 221 and 223 to 225 are controlled not to project.

Based on the principle of similarity, the processor 214 may correspondingly control each of the imaging devices 233 to 235 to capture the first test pattern independently projected by each of the corresponding projection devices 223 to 225 to obtain the corresponding first image frames 403 to 405, and the details of which are not reproduced here.

In step S340, the processor 214 obtains multiple first homography matrices based on the first image frames 401 to 405.

The multiple first image frames 401 to 405 are respectively an i-th first image frame corresponding to an i-th projection device among the projection devices 221 to 225. The processor 214 may be configured to: determine multiple first coordinates of the multiple first point positions of the first test pattern in the i-th first image frame, and execute a geometric transformation algorithm based on the multiple first coordinates to obtain an i-th first homography matrix (represented by Mc_i below) among the multiple first homography matrices.

For example, for the first image frame 401 (such as a 1st first image frame) corresponding to the projection device 221 (such as a 1st projection device), the processor 214 may determine the coordinates of part or all of the multiple first point positions in the first test pattern in the first image frame 401 to serve as (multiple) first coordinates of the geometric transformation algorithm.

In the scenario of FIG. 4, assuming a dimension of the first image frame 401 is H×W (H being the height, and W being the width), a specific coordinate of an upper left corner of the first image frame 401 may, for example, correspond to a coordinate (0, 0), and a specific coordinate of a lower right corner of the first image frame 401 may, for example, correspond to a coordinate (H−1, W−1), but the disclosure is not limited thereto.

In this condition, the processor 214 may, for example, find out specific coordinates of the first point positions in the first image frame 401 to serve as the corresponding first coordinates.

In an embodiment, the first point positions of the first test pattern may have corresponding point coordinates in the first test pattern, and the processor 214 may record (part or all of) the multiple point coordinates together with the corresponding first coordinates (specific coordinates).

The point coordinates are, for example, index coordinates (matrix coordinates) of the multiple first point positions arranged in an A×B matrix in the first test pattern. For example, a certain first point is located in an (a−1)th row and a (b−1)th column in the A×B matrix, and the point coordinate is (a−1, b−1). Each point coordinate and the corresponding first coordinate may be the same or different. For example, for a first point 411 in the first image frame 401, which is a point located at the upper left corner of the first test pattern, the point coordinate may be understood as (0, 0). A specific coordinate of the first point 411 in the first image frame 401 is (x1, y1), and a first coordinate corresponding to the first point 411 is, for example, (x1, y1).

To give another example, for a first point 412 in the first image frame 401, which is a point located at the lower right corner of the first test pattern, the point coordinate may be understood as (A−1, B−1). A specific coordinate of the first point 412 in the first image frame 401 is (x2, y2), and a first coordinate corresponding to the first point 412 may be (x2, y2).

Based on the principle of similarity, the processor 214 may determine the first coordinates corresponding to each point coordinate of the first test pattern in the first image frame 401.

In an embodiment, the processor 214 may execute a geometric transformation algorithm based on the first coordinates of each first point in the first image frame 401 to determine a first homography matrix Mc_1 (such as a 1st first homography matrix).

In an embodiment, the geometric transformation algorithm is, for example, a conversion between a camera coordinate system and a projection coordinate system, and uses a homography matrix to represent the conversion relationship between these positions. The geometric transformation algorithm is, for example, a geometric and photometric registration algorithm, and the details of which may, for example, refer to the literature “Camera-Based Calibration Techniques for Seamless Multi-Projector Displays”.

In an embodiment, after the first coordinate (the specific coordinate) and the point coordinate corresponding to each first point in the first image frame 401 are known, the processor 214 may determine a corresponding (first) homography matrix to serve as the corresponding first homography matrix Mc_1 based on the teachings of the foregoing literature.

For the other first image frames 402 to 405, the processor 214 may determine corresponding first homography matrices Mc_2 to Mc_5 based on the foregoing principle, and the details of which are not reproduced here.

In the embodiment of the disclosure, the multiple first homography matrices may respectively correspond to the multiple conversion matrices. For example, the first homography matrix Mc_i may correspond to the conversion matrix Md_i, and both correspond to an i-th imaging device and/or an i-th projection device.

In step S350, the processor 214 respectively converts the corresponding first homography matrices based on the conversion matrices to obtain multiple second homography matrices.

In an embodiment, an i-th second homography matrix among the multiple second homography matrices is represented by Ma′_i=Md_i*Mc_i. For example, the multiple conversion matrices Md_i may, for example, be respectively the conversion matrices for converting the sub-projection images captured by each of the imaging devices 231 to 235 into a coordinate system of an overall projection image. The multiple first homography matrices Mc_i may, for example, respectively be coordinate system conversion data between the multiple projection devices 221 to 225 and the imaging devices 231 to 235. The multiple second homography matrices Ma′_i may, for example, respectively be homography matrices for converting each sub-projection image into the coordinate system of the overall projection image to determine the compensation needed for each sub-projection image.

In step S360, the processor 214 combines the multiple second homography matrices to obtain a compensation coefficient coordinate matrix corresponding to the projection devices 221 to 225.

In an embodiment, the compensation coefficient coordinate matrix is represented by:

$$IMs = {\sum }_{i = 1}^{N} {Ma}^{′} \_i$$

where Nis a number of the multiple second homography matrices, that is, a number of the multiple conversion matrices (such as 5 as previously mentioned). The compensation coefficient coordinate matrix IMs is used to represent coordinate compensation relationships required to be applied to each sub-projection image in the coordinate system of the overall projection image.

In an embodiment, the compensation coefficient coordinate matrix IMs may include, for example, mapping matrices corresponding to the projection coordinate systems of the projection devices 221 to 225, for describing geometric compensation information of each sub-projection image relative to the overall projection image.

In an embodiment, the processor 214 may further execute step S370 to control the projection devices 221 to 225 to apply the compensation coefficient coordinate matrix IMs. Each of the projection devices 221 to 225 projects the calibrated sub-projection images.

In this way, when at least one sub-projection image in the projection image is shifted due to external factors, the compensation coefficient coordinate matrix IMs may be obtained through the foregoing steps to calibrate the projection devices 221 to 225. After calibration, the calibrated sub-projection images projected by each of the projection devices 221 to 225 to be blended with higher precision, thereby forming a complete blended image with better image uniformity.

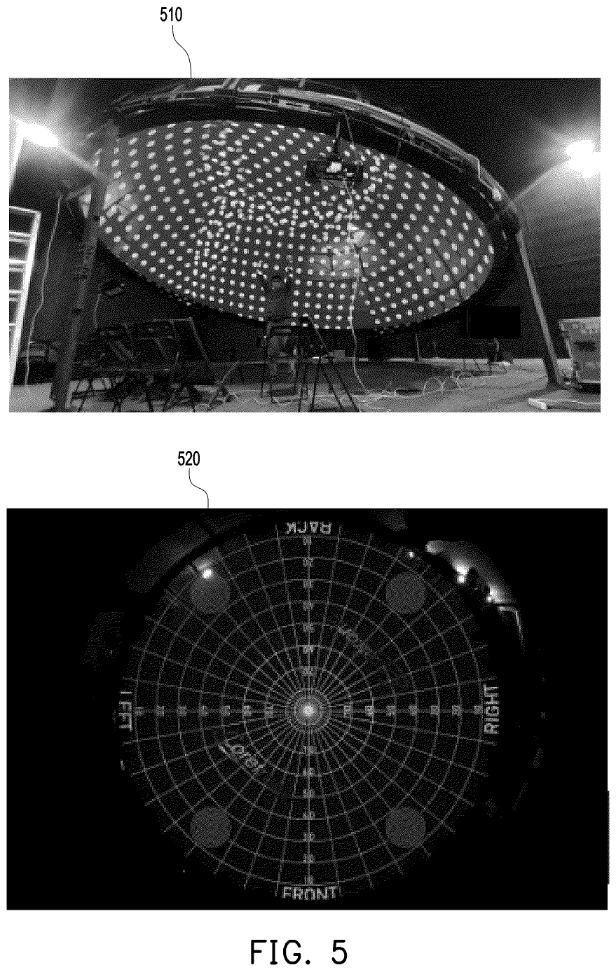

Please refer to FIG. 5, which is an application scenario diagram according to an embodiment of the disclosure. In FIG. 5, a scene 510 is, for example, a state of the sub-projection images projected by each of the projection devices 221 to 225 before calibration is performed. Additionally, a scene 520 is, for example, a complete projection image blended by the sub-projection images projected by each of the projection devices 221 to 225 after calibration has been performed on the projection devices 221 to 225. From the scene 520, it can be seen that each sub-projection image is accurately blended, resulting in the complete projection image formed to have good image uniformity.

Please refer to FIG. 6, which is a flow chart of determining a conversion matrix according to an embodiment of the disclosure. The method of the embodiment may be executed by the control device 210 in FIG. 2. The details of each step in FIG. 6 will be illustrated below in conjunction with the elements shown in FIG. 2.

In step S610, the processor 214 controls each of the projection devices 221 to 225 to project a second test pattern. In step S620, the processor 214 controls a main imaging device 710 to capture the second test pattern projected by each of the projection devices 221 to 225 to obtain multiple reference image frames that have the second test pattern.

In the embodiment of disclosure, the second test pattern may include multiple second points. For ease of understanding, it is assumed below that the second test pattern is the same as the first test pattern previously mentioned, but this is only used as an example and is not intended to limit the possible implementations of the disclosure. In other embodiments, designers may choose other types of patterns to serve as the second test pattern according to needs. In an embodiment, a number of the multiple second points of the second test pattern is, for example, less than a number of the multiple first point positions of the first test pattern. A directionality of the second test pattern may be determined from a distribution of the multiple second points of the second test pattern.

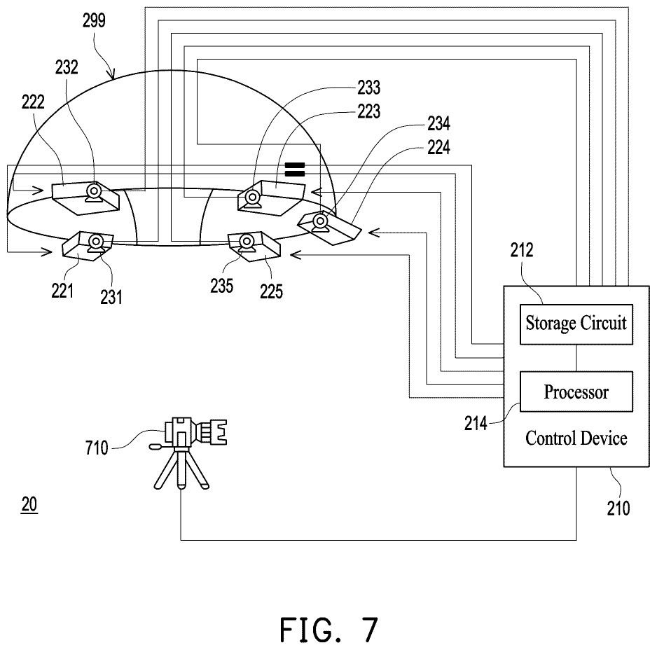

Please refer to FIG. 7, which is another schematic diagram of the projection system according to FIG. 2. In the embodiment, the projection system 20 may further include the main imaging device 710 connected to the control device 210. An imaging range of the main imaging device 710 covers respective projection ranges of the projection devices 221 to 225. In other words, the imaging range of the main imaging device 710 covers a projected region of a blended projection image on the projection surface 299. In the embodiment, the control device 210 of the projection system 20 is, for example, set in the same local area network (LAN) as the projection devices 221 to 225.

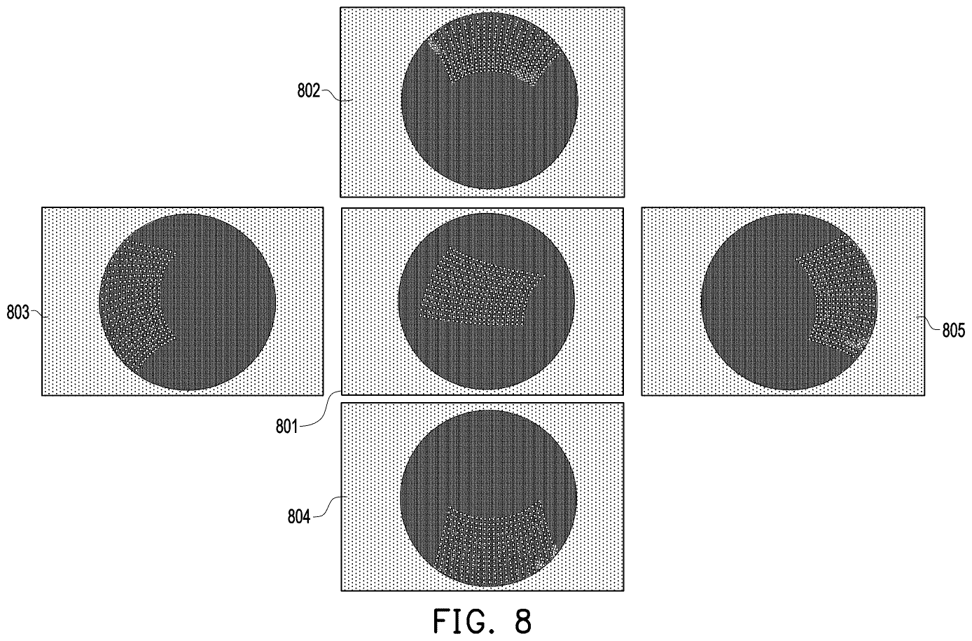

Please refer to FIG. 8, which is a schematic diagram of reference image frames obtained by a main imaging device according to an embodiment of the disclosure.

In an embodiment, the processor 214 may control the projection devices 221 to 225 to independently project the second test pattern in sequence, and control the main imaging device 710 to capture when the corresponding projection devices 221 to 225 independently project the second test pattern to obtain corresponding reference image frames.

For example, the processor 214 may independently control the projection device 221 to project the second test pattern, and control the corresponding main imaging device 710 to capture the second test pattern projected by the projection device 221 to obtain a reference image frame 801 that has the second test pattern. From the reference image frame 801, it can be seen that the second test pattern projected by the projection device 221 appears distorted in response to a projected region on the projection surface 299.

In other words, the processor 214 may control only the projection device 221 to project the second test pattern and control the main imaging device 710 to capture to obtain the reference image frame 801 in a condition where the other projection devices 222 to 225 are controlled not to project.

Similarly, the processor 214 may independently control the projection device 222 to project the second test pattern and control the corresponding main imaging device 710 to capture the second test pattern projected by the projection device 222 to obtain a reference image frame 802 that has the second test pattern. In other words, the processor 214 may control only the projection device 222 to project the second test pattern and control the main imaging device 710 to capture to obtain the reference image frame 802 in a condition where the other projection devices 221 and 223 to 225 are controlled not to project,

Based on the principle of similarity, the processor 214 may correspondingly control the main imaging device 710 to capture the second test pattern independently projected by each of the corresponding projection devices 223 to 225 respectively corresponding to an imaging device among the imaging devices 233 to 235, to obtain corresponding reference image frames 803 to 805, and the detail of which are not reproduced here.

In step S630, the processor 214 obtains multiple reference homography matrices based on the reference image frames 801 to 805.

The multiple reference image frames 801 to 805 include respective i-th reference image frames. Each of the i-th reference image frames has the second test pattern projected by a corresponding i-th projection device among the projection devices 221 to 225. The processor 214 may be configured to: determine multiple reference coordinates of the multiple second points in the second test pattern in the i-th reference image frame, and execute a geometric transformation algorithm based on the multiple reference coordinates to obtain an i-th reference homography matrix (represented by Ma_i below) among the multiple reference homography matrices.

For example, for the reference image frame 801 (such as a first reference image frame) corresponding to the projection device 221 (such as a first projection device), the processor 214 may determine a coordinate of each second point in the second test pattern in the reference image frame 801 to serve as a reference coordinate for the geometric transformation algorithm. In other embodiments, the processor 214 may, for example, only determine coordinates of part of the second points in the second test pattern in the reference image frame 801 to serve as the reference coordinates.

In the scenario of FIG. 8, assuming a dimension of the reference image frame 801 is H1×W1 (H1 being the height, and W1 being the width), a specific coordinate of an upper left corner of the reference image frame 801 may, for example, correspond to a coordinate (0, 0), and a specific coordinate of a lower right corner of the reference image frame 801 may, for example, correspond to a coordinate (H1−1, W1−1), but the disclosure is not limited thereto.

In this condition, the processor 214 may, for example, find out the specific coordinate of each second point in the reference image frame 801 to serve as corresponding reference coordinates.

In an embodiment, each second point of the second test pattern may have corresponding point coordinates in the second test pattern, and the processor 214 may record each point coordinate together with the corresponding reference coordinate (the specific coordinate).

In the embodiment of the disclosure, the relationship between the point coordinates of the second points and the corresponding reference coordinates may refer to the related descriptions of the relationship between the point coordinates of the first point positions and the corresponding first coordinates in the foregoing embodiments, and will not be reproduced here.

In an embodiment, the processor 214 may execute a geometric transformation algorithm based on the reference coordinate of each second point in the reference image frame 801 to determine a reference homography matrix Ma_1 (such as a first reference homography matrix).

In an embodiment, after the reference coordinate and the point coordinate corresponding to each second point in the reference image frame 801 are known, the processor 214 may determine a corresponding homography matrix to serve as the corresponding reference homography matrix Ma_1 based on the teachings of the foregoing literature “Camera-Based Calibration Techniques for Seamless Multi-Projector Displays”.

For the other reference image frames 802 to 805, the processor 214 may determine the corresponding reference homography matrixs Ma_2 to Ma_5 based on the foregoing principle, and the details of which are not reproduced here. In the embodiment, the reference homography matrices Ma_1 to Ma_5 correspond to a coordinate system of the main imaging device 710. By installing the main imaging device 710, the projection system 20 may obtain the reference homography matrices Ma_1 to Ma_5 to achieve fast on-site blending and fusion of the multiple sub-projection images when the multiple projection devices 221 to 225 are installed. The reference homography matrices Ma_1 to Ma_5 are related to calibration information such as warping of the projection image, blending of overlapping regions of sub-projection images, black level, adjustment and masking.

In step S640, the processor 214 controls each of the imaging devices 231 to 235 to individually capture the second test pattern projected by each of the corresponding projection devices 221 to 225 to obtain multiple second image frames that have the second test pattern.

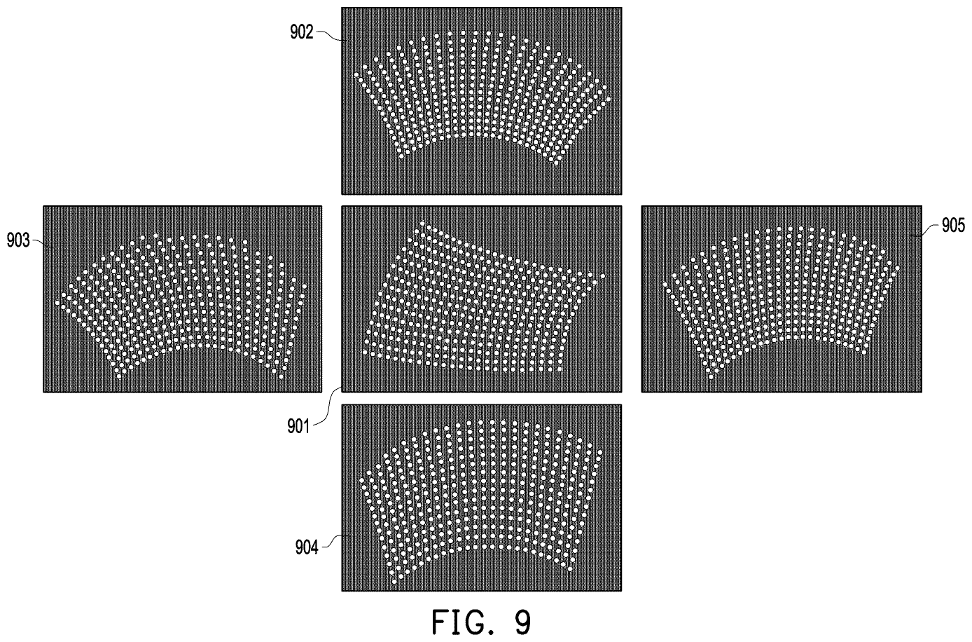

Please refer to FIG. 9, which is a schematic diagram of second image frames obtained by each imaging device according to an embodiment of the disclosure.

In the embodiment, the second test pattern may, for example, include the multiple second points, and the multiple second points may, for example, be arranged as a C×D bitmap. In the scenario of FIG. 9, C (the number of rows in the matrix) and D (the number of columns in the matrix) are, for example, 15 and 24 respectively, but the disclosure is not limited thereto.

In an embodiment, the processor 214 may control the projection devices 221 to 225 to independently project the second test pattern in sequence, and control the corresponding imaging devices 231 to 235 to capture the second test pattern independently projected by the corresponding projection devices to obtain corresponding second image frames 901 to 905.

For example, the processor 214 may independently control the projection device 221 to project the second test pattern, and control the corresponding imaging device 231 to capture the second test pattern projected by the projection device 221 to obtain the second image frame 901 that has the second test pattern. From the second image frame 901, it can be seen that the second test pattern projected by the projection device 221 appears distorted due to a projected region on the projection surface 299.

In other words, the processor 214 may control only the projection device 221 to project the second test pattern and control the imaging device 231 to capture the second test pattern projected by the projection device 221 to obtain the second image frame 901 in a condition where the other projection devices 222 to 225 are controlled not to project.

Similarly, the processor 214 may independently control the projection device 222 to project the second test pattern, and control the corresponding imaging device 232 to capture the second test pattern projected by the projection device 222 to obtain the second image frame 902 that has the second test pattern. In other words, the processor 214 may control only the projection device 222 to project the second test pattern and control the imaging device 232 to capture the second test pattern to obtain the second image frame 902 in a condition where the other projection devices 221 and 223 to 225 are controlled not to project.

Based on the principle of similarity, the processor 214 may correspondingly control each of the imaging devices 233 to 235 to capture the second test pattern independently projected by each of the corresponding projection devices 223 to 225 to obtain the corresponding second image frames 903 to 905. The details of which are not reproduced here.

In an embodiment, when the projection device 221 is independently controlled to project the second test pattern, the processor 214 may control the main imaging device 710 and the corresponding imaging device 231 to capture the second test pattern projected by the projection device 221 to respectively obtain the reference image frame 801 and the second image frame 901 that have the second test pattern.

By the same token, when the projection device 222 is independently controlled to project the second test pattern, the processor 214 may control the main imaging device 710 and the corresponding imaging device 232 to capture the second test pattern projected by the projection device 222 to respectively obtain the reference image frame 802 and the second image frame 902 that have the second test pattern.

In other words, in some embodiments, (at least a part of) step S620 may be performed with (at least a part of) step S640 at the same time.

In step S650, the processor 214 obtains multiple second homography matrices based on the second image frames 901 to 905.

The multiple second image frames 901 to 905 include respective i-th second image frames. Each of the i-th second image frames has the second test pattern projected by the corresponding i-th projection device among the projection devices 221 to 225. The processor 214 may be configured to: determine multiple second coordinates of the multiple second points in the second test pattern in the i-th second image frame, and execute a geometric transformation algorithm based on the multiple second coordinates to obtain an i-th second homography matrix (represented by Mb_i below) among the multiple second homography matrices.

For example, for the second image frame 901 (such as a first second image frame) corresponding to the projection device 221 (such as the first projection device), the processor 214 may determine coordinates of each second point in the second test pattern in the second image frame 901 to serve as second coordinates for the geometric transformation algorithm.

In the scenario of FIG. 9, assuming a dimension of the second image frame 901 is H2×W2 (H2 being the height, and W2 being the width), a specific coordinate of an upper left corner of the second image frame 901 may, for example, correspond to a coordinate (0, 0), and a specific coordinate of a lower right corner of the second image frame 901 may, for example, correspond to a coordinate (H2−1, W2−1), but the disclosure is not limited thereto.

In this condition, the processor 214 may, for example, find out the specific coordinate of each second point in the second image frame 901 to serve as a corresponding second coordinate.

In an embodiment, each second point of the second test pattern may have a corresponding point coordinate in the second test pattern, and the processor 214 may record each point coordinate together with the corresponding second coordinate (the specific coordinate).

In the embodiment of the disclosure, the relationship between the point coordinates of the second points and the corresponding second coordinates may refer to the related description of the relationship between the point coordinates of the first point positions and the corresponding first coordinates in the foregoing embodiment, and will not be reproduced here.

In an embodiment, the processor 214 may execute a geometric transformation algorithm based on the second coordinate of each second point in the second image frame 901 to determine a second homography matrix Mb_1 (such as a first second homography matrix).

In an embodiment, after the second coordinates and the point coordinates corresponding to respective second points in the second image frame 901 are known, the processor 214 may determine a corresponding homography matrix as the corresponding second homography matrix Mb_1 based on the teachings of the foregoing literature “Camera-Based Calibration Techniques for Seamless Multi-Projector Displays”.

For the other second image frames 902 to 905, the processor 214 may determine corresponding second homography matrixes Mb_2 to Mb_5 based on the foregoing principle, and the details of which are not reproduced here. The second homography matrices Mb_1 to Mb_5 correspond to a coordinate system of the imaging devices 231 to 235.

In an embodiment, the steps of the control device 210 capturing the reference image frames and obtaining the reference homography matrices (Ma_i) by the main imaging device 710 (steps S620 to S630) may be performed at the same time with the steps of the control device 210 capturing the second image frames and obtaining the second homography matrices (Mb_i) by the imaging devices 231 to 235 (steps S640 to S650).

In step S660, the processor 214 respectively converts the corresponding second homography matrices based on the respective reference homography matrices to obtain the multiple conversion matrices.

In an embodiment, an i-th conversion matrix among the multiple conversion matrices may be represented by: Md_i=Ma_i*Mb_i. Md_i may, for example, represent a matrix equation that indicates the conversion relationship between the reference homography matrices Ma_i (involving the main imaging device 710) and the second homography matrices Mb_i (involving the imaging devices 231 to 235).

In the embodiment, coordinate systems used by the matrices may be respectively described as follows: (1) the first homography matrix Mc_i is used to represent a coordinate conversion relationship between the projection devices 221 to 225 and the corresponding imaging devices 231 to 235; (2) the second homography matrix Mb_i is used to represent a coordinate conversion relationship between the second test pattern and the imaging devices 231 to 235; (3) the reference homography matrix Ma_i is used to represent a coordinate conversion relationship between the second test pattern and the main imaging device 710; and (4) the conversion matrix Md_i=Ma_i*Mb_i is used to represent a coordinate conversion relationship between the imaging devices 231 to 235 and the main imaging device 710.

In an embodiment, the concept of the disclosure may be understood to include two stages: (1) an installation stage corresponding to FIG. 6 (such as a first on-site blending); and (2) a maintenance stage corresponding to FIG. 3 (such as a subsequent image calibration). In an embodiment, the effect of quick on-site blending may be achieved by the reference homography matrices Ma_1 to Ma_5. In order to execute the process of the maintenance stage, the related maintenance personnel may first determine the conversion matrices Md_1 to Md_5 respectively corresponding to the projection devices 221 to 225 by implementing the process in FIG. 6 (involving the main imaging device 710) to learn the conversion matrices Md_1 to Md_5 between the coordinate system corresponding to the main imaging device 710 and the coordinate systems corresponding to the imaging devices 231 to 235 when the projection image has completed blending. The conversion matrices Md_1 to Md_5 are, for example, stored in the storage circuit 212 of the control device 210. Subsequently, when subsequent maintenance of the projection devices 221 to 225 is needed, the related maintenance personnel may directly (remotely) implement the process in FIG. 3 based on the previously determined conversion matrices Md_1 to Md_5 without the need to install the main imaging device 710. In other words, according to the (current) multiple first homography matrices Mc_1 to Mc_5 corresponding to the imaging devices 231 to 235 and the (stored) foregoing conversion matrices Md_1 to Md_5, the second homography matrices Ma′_1 to Ma′_5 corresponding to the coordinate system of the main imaging device 710 may be obtained. In this way, even though the main imaging device 710 with an imaging range covering the individual projection ranges of the projection devices 221 to 225 is not needed, the current blending situation of the multiple sub-projection images (related to Ma′_1 to Ma′_5) may be obtained based on the foregoing conversion relationship equation, and then the compensation coefficient coordinate matrix IMs may be learned by combining Ma′_1 to Ma′_5 to allow the multiple sub-projection images projected by the projection devices 221 to 225 to be calibrated and blended into a complete projection image (the image effect of seamless blending).

In this way, the maintenance/calibration operation of the projection devices 221 to 225 may be completed in a manner where the viewing experience and/or venue operation may not be affected in a condition where the related installation time, cost, and complexity are saved.

In an embodiment, the control device 210 executing the maintenance stage of FIG. 3 may be different from the control device 210 executing the installation stage of FIG. 6. The trigger timing for the maintenance stage may be, for example, when the control device 210 (remotely or locally) connects and activates the projection devices 221 to 225 for maintenance, a pre-set schedule by the control device 210, or specific conditions of the projection devices 221 to 225 (such as power-on, predetermined schedule, or error alert) and other time points.

To sum up, the embodiment of the disclosure can effectively enhance the operation efficiency, maintenance convenience, and daily operation stability of the blending technology of the multiple projection devices.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A projection blending and calibration method, comprising the following steps:
obtaining a plurality of conversion matrices respectively corresponding to a plurality of projection devices by a control device, wherein sub-projection images projected by the plurality of projection devices are to be blended into a projection image, and the plurality of projection devices respectively correspond to a plurality of imaging devices;
controlling each of the plurality of projection devices by the control device to project a first test pattern;
controlling each of the plurality of imaging devices by the control device to individually capture the first test pattern projected by each of the corresponding plurality of projection devices to obtain a plurality of first image frames that have the first test pattern;
obtaining a plurality of first homography matrices based on the plurality of first image frames by the control device, wherein the plurality of first homography matrices respectively correspond to the plurality of conversion matrices;
converting each of the plurality of first homography matrices respectively based on a corresponding conversion matrix of the plurality of conversion matrices to obtain a plurality of second homography matrices by the control device; and
combining the plurality of second homography matrices by the control device to obtain a compensation coefficient coordinate matrix corresponding to the plurality of projection devices.

2. The method according to claim 1, wherein the plurality of first image frames comprise an i-th first image frame corresponding to an i-th projection device among the plurality of projection devices, i is an index value, and the first test pattern comprises a plurality of first point positions, wherein the steps of obtaining the plurality of first homography matrices based on the plurality of first image frames by the control device further comprise:
determining a plurality of first coordinates of the plurality of first point positions in the i-th first image frame; and
executing a geometric transformation algorithm based on the plurality of first coordinates to obtain an i-th first homography matrix among the plurality of first homography matrices.

3. The method according to claim 1, wherein an i-th second homography matrix among the plurality of second homography matrices is represented by:
$${Ma}^{′} \_i = Md\_i * Mc\_i$$
wherein Md_i is an i-th conversion matrix among the plurality of conversion matrices, Mc_i is an i-th first homography matrix among the plurality of first homography matrices, and i is an index value.

4. The method according to claim 1, wherein the compensation coefficient coordinate matrix is represented by:
$$IMs = {\sum }_{i = 1}^{N} {Ma}^{′} \_i$$
wherein Ma′_i is an i-th second homography matrix among the plurality of second homography matrices, i is an index value, and Nis a number of the plurality of second homography matrices.

5. The method according to claim 1, further comprising the following steps:
controlling the plurality of projection devices by the control device to apply the compensation coefficient coordinate matrix, and
projecting a calibrated sub-projection image by each of the plurality of projection devices.

6. The method according to claim 1, wherein before the step of the plurality of conversion matrices respectively corresponding to the plurality of projection devices obtained, the method further comprises the following steps:
controlling each of the plurality of projection devices by the control device to project a second test pattern;
controlling a main imaging device by the control device to capture the second test pattern projected by each of the plurality of projection devices to obtain a plurality of reference image frames that have the second test pattern, wherein an imaging range of the main imaging device covers individual projection ranges of the plurality of projection devices;
obtaining a plurality of reference homography matrices based on the plurality of reference image frames by the control device;
controlling each of the plurality of imaging devices by the control device to individually capture the second test pattern projected by each of the corresponding plurality of projection devices to obtain a plurality of second image frames that have the second test pattern;
obtaining a plurality of second homography matrices based on the plurality of second image frames by the control device, wherein the plurality of second homography matrices respectively correspond to the plurality of reference homography matrices; and
converting each of the plurality of second homography matrices respectively based on a corresponding reference homography matrix among the plurality of reference homography matrices by the control device to obtain the plurality of conversion matrices.

7. The method according to claim 6, wherein the plurality of reference image frames comprise respective i-th reference image frames, and each of the i-th reference image frames has the second test pattern projected by a corresponding i-th projection device among the plurality of projection devices;
wherein the plurality of second image frames comprise respective i-th second image frames, and each of the i-th second image frames has the second test pattern projected by the corresponding i-th projection device among the plurality of projection devices, wherein i is an index value.

8. The method according to claim 7, wherein an i-th conversion matrix among the plurality of conversion matrices is represented by:
$$Md\_i = Ma\_i * Mb\_i$$
wherein Ma_i is an i-th reference homography matrix among the plurality of reference homography matrices, and Mb_i is an i-th second homography matrix among the plurality of second homography matrices.

9. The method according to claim 6, wherein the plurality of reference image frames comprise respective i-th reference image frames corresponding to respective i-th projection devices among the plurality of projection devices, each of the i-th reference image frames has the second test pattern having a plurality of second points, wherein i is an index value, and wherein the steps of obtaining the plurality of reference homography matrices based on the plurality of reference image frames by the control device comprise:
determining a plurality of reference coordinates of the plurality of second points in the i-th reference image frame; and
executing a geometric transformation algorithm based on the plurality of reference coordinates to obtain an i-th reference homography matrix among the plurality of reference homography matrices.

10. The method according to claim 6, wherein the plurality of second image frames comprise respective i-th second image frames corresponding to respective i-th projection devices among the plurality of projection devices, each of the i-th second image frames has the second test pattern having a plurality of second points, wherein i is an index value, and wherein the steps of obtaining the plurality of second homography matrices based on the plurality of second image frames by the control device comprise:
determining a plurality of second coordinates of the plurality of second points in the i-th second image frame; and
executing a geometric transformation algorithm based on the plurality of second coordinates to obtain an i-th second homography matrix among the plurality of second homography matrices.

11. A control device, coupled to a plurality of projection devices, and configured to control the plurality of projection devices, comprising:
a storage circuit, configured to store a program code; and
a processor, coupled to the storage circuit and accessing the program code to:
obtain a plurality of conversion matrices respectively corresponding to the plurality of projection devices by the control device, wherein sub-projection images projected by the plurality of projection devices are to be blended into a projection image, and the plurality of projection devices respectively correspond to a plurality of imaging devices;
control each of the plurality of projection devices by the control device to project a first test pattern;
control each of the plurality of imaging devices by the control device to individually capture the first test pattern projected by each of the corresponding plurality of projection devices to obtain a plurality of first image frames that have the first test pattern;
obtain a plurality of first homography matrices based on the plurality of first image frames by the control device, wherein the plurality of first homography matrices respectively correspond to the plurality of conversion matrices;
convert each of the plurality of first homography matrices respectively based on a corresponding conversion matrix of the plurality of conversion matrices to obtain a plurality of second homography matrices by the control device; and
combine the plurality of second homography matrices by the control device to obtain a compensation coefficient coordinate matrix corresponding to the plurality of projection devices.

12. The control device according to claim 11, wherein the plurality of first image frames comprise an i-th first image frame corresponding to an i-th projection device among the plurality of projection devices, i is an index value, and the first test pattern comprises a plurality of first point positions, wherein the processor is configured to:
determine a plurality of first coordinates of the plurality of first point positions in the i-th first image frame; and
execute a geometric transformation algorithm based on the plurality of first coordinates to obtain an i-th first homography matrix among the plurality of first homography matrices.

13. The control device according to claim 11, wherein an i-th second homography matrix among the plurality of second homography matrices is represented by:
$${Ma}^{′} \_i = Md\_i * Mc\_i$$
wherein Md_i is an i-th conversion matrix among the plurality of conversion matrices, Mc_i is an i-th first homography matrix among the plurality of first homography matrices, and i is an index value.

14. The control device according to claim 11, wherein the compensation coefficient coordinate matrix is represented by:
$$IMs = {\sum }_{i = 1}^{N} {Ma}^{′} \_i$$
wherein Ma′_i is an i-th second homography matrix among the plurality of second homography matrices, i is an index value, and Nis a number of the plurality of second homography matrices.

15. The control device according to claim 11, wherein the processor is further configured to:
control the plurality of projection devices to apply the compensation coefficient coordinate matrix to allow each of the plurality of projection devices to project a sub-projection image that has been calibrated.

16. The control device according to claim 11, wherein before the plurality of conversion matrices respectively corresponding to the plurality of projection devices are obtained, the processor is further configured to:
control each of the plurality of projection devices to project a second test pattern;
control a main imaging device to capture the second test pattern projected by each of the plurality of projection devices to obtain a plurality of reference image frames that have the second test pattern, wherein an imaging range of the main imaging device covers individual projection ranges of the plurality of projection devices;
obtain a plurality of reference homography matrices based on the plurality of reference image frames;
control each of the plurality of imaging devices to individually capture the second test pattern projected by each of the corresponding plurality of projection devices to obtain a plurality of second image frames that have the second test pattern;
obtain a plurality of second homography matrices based on the plurality of second image frames, wherein the plurality of second homography matrices respectively correspond to the plurality of reference homography matrices; and
convert the corresponding plurality of second homography matrices respectively based on the reference homography matrices to obtain the plurality of conversion matrices.

17. The control device according to claim 16, wherein the plurality of reference image frames comprise respective i-th reference image frames, and each of the i-th reference image frames has the second test pattern projected by an i-th projection device among the plurality of projection devices;
wherein the plurality of second image frames comprise respective i-th second image frames, and each of the i-th second image frames has the second test pattern projected by the i-th projection device among the plurality of projection devices, wherein i is an index value.

18. The control device according to claim 17, wherein an i-th conversion matrix among the plurality of conversion matrices is represented by:
$$Md\_i = Ma\_i * Mb\_i$$
wherein Ma_i is an i-th reference homography matrix among the plurality of reference homography matrices, Mb_i is an i-th second homography matrix among the plurality of second homography matrices.

19. The control device according to claim 16, wherein the plurality of reference image frames comprise respective i-th reference image frames corresponding to respective i-th projection device among the plurality of projection devices, wherein i is an index value, and the second test pattern comprises a plurality of second points, wherein the processor is configured to:
determine a plurality of reference coordinates of the plurality of second points in the i-th reference image frame; and
execute a geometric transformation algorithm based on the plurality of reference coordinates to obtain an i-th reference homography matrix among the plurality of reference homography matrices.

20. The control device according to claim 16, wherein the plurality of second image frames comprise an i-th second image frame corresponding to an i-th projection device among the plurality of projection devices, i is an index value, and the second test pattern comprises a plurality of second points, wherein the processor is configured to:
determine a plurality of second coordinates of the plurality of second points in the i-th second image frame; and
execute a geometric transformation algorithm based on the plurality of second coordinates to obtain an i-th second homography matrix among the plurality of second homography matrices.

21. The control device according to claim 11, wherein the control device is disposed inside one of the plurality of projection devices.

22. A projection system, comprising:
a plurality of projection devices, respectively configured to project sub-projection images, wherein the individual sub-projection images of the plurality of projection devices are configured to be blended into a projection image;
a plurality of imaging devices; and
a control device, coupled to the plurality of projection devices and the plurality of imaging devices, and configured to:
obtain a plurality of conversion matrices respectively corresponding to the plurality of projection devices, wherein the sub-projection images projected by the plurality of projection devices are to be blended into the projection image, and the plurality of projection devices respectively correspond to the plurality of imaging devices;
control each of the plurality of projection devices to project a first test pattern;
control each of the plurality of imaging devices to individually capture the first test pattern projected by each of the corresponding projection devices to obtain a plurality of first image frames that have the first test pattern;
obtain a plurality of first homography matrices based on the plurality of first image frames, wherein the plurality of first homography matrices respectively correspond to the plurality of conversion matrices;
convert each of the plurality of first homography matrices respectively based on a corresponding conversion matrix of the plurality of conversion matrices to obtain a plurality of second homography matrices; and
combine the plurality of second homography matrices to obtain a compensation coefficient coordinate matrix corresponding to the plurality of projection devices.

23. The projection system according to claim 22, wherein the individual sub-projection images of the plurality of projection devices are to be blended into the projection image on a dome projection surface.
